(19) United States
(12) Patent Application Publication
(10) Pub. No.: US 2014/0365300 A1
(43) Pub. Date: Dec. 11, 2014

(54) SYSTEM AND METHOD FOR ANONYMOUSLY VIEWING NEWSLETTERS AND EMAIL ADVERTISMENTS

(71) Applicant: PAUL SCATURRO, GARDEN CITY, NY (US)

(72) Inventor: PAUL SCATURRO, GARDEN CITY, NY (US)

(21) Appl. No.: 13/914,566

(22) Filed: Jun. 10, 2013

(51) Int. Cl. G06Q 30/02

(52) U.S. Cl. CPC G06Q 30/0251
USPC 705/14.49

(57) ABSTRACT

Systems and methods are provided for assisting merchants in making their advertising and information content available to a wide array of users who do not subscribe to the merchant's newsletters or participate in the merchant's advertising promotions.

### CROSS-REFERENCE TO RELATED APPLICATIONS

The present invention claims priority to U.S. Provisional Patent Application Ser. No. 61/657,812, which is incorporated herein by reference in its entirety, titled “A content provisioning system and method”, was filed on Jun. 10, 2012.

### BACKGROUND OF THE INVENTION

1. Field of the Invention

The present invention is generally related to advertising. The present invention relates specifically to systems and methods for distributing emailed newsletters and/or email advertisements and/or electronic coupons from merchants advertising goods and services via a single an interne based advertising platform to a plurality of end users in lieu of using a subscription based email model.

2. Description of the Related Art

Newsletters today are used by a variety of people to promote their activities, sell a product, or just to stay connected with consumers or followers. Currently merchants, organizations create newsletters with popular software such as Constant Contact or Vertical Response. With these programs and others like them the merchant sending out the newsletter has a stored email list. The merchants obtain their respective email lists by soliciting or enticing customers with incentives in exchange for the customer's personal email address. Such processes are well-known, and are sometimes referred to as ‘opt-in’ systems in which potential customers offer up their email on a webpage or submitting it physically to the company. The merchant maintains opt-in email lists, wherein potential recipients are able to affirmatively choose to be included on an email list of a business or organization and receive emails from that them. With this opt in email list the company will send the customers their latest promotions in the form of an electronic letter. If the customer so chooses at any time they can ‘opt-out’ and unsubscribe to the newsletter.

FIG. 1 illustrates an exemplary ‘opt-in’ system according to the prior art including a plurality of merchants 42, 44, 46, 48 who can provide emails (i.e., “content”) which can include newsletters and other content to users over a network 92 to a user's email client 20. The merchants 42, 44, 46 and 48 send the emails only to those users who affirmatively choose to be included on an email list of the merchants 42, 44, 46, 48.

Merchants developed the opt-in email list approach to increase the likelihood that emails will reach and be read by the intended recipients. However, even in situations where a recipient has opted-in to receive emails from a specific merchant, it is sometimes difficult for the recipient to recognize an email, such as a marketing email, sent from that merchant (as distinguished from unwanted spam). As a result, the recipient may inadvertently ignore and/or delete an email that came from the merchant even though the recipient had previously opted-in to receive such emails. In addition, unscrupulous merchants may use the process wherein a previously opted-in recipient chooses instead to now opt-out as a sign that the email address of that recipient is live and in use, and May therefore increase the volume of unwanted emails to that address.

Another drawback of an “opt-in” system is that the customer or user reveals his or her email address which can be sold by the merchant to other merchants resulting in an abundance of spam mail. This is problematic in that the merchants usually have a limited audience of their own customers who sign up for such letters. Ideally, the merchants would prefer to attract other potential customers to sign up for their newsletters and have made attempts to attract other customers by greatly increasing their exposure to advertising on the internet.

In addition to newsletters some merchants also offer electronic internet coupons to reach potential customers who are not on their email list. They use dedicated services such as coupon or offers websites, Valpak, Yelp, Coupon Clipper, YellowPages.com . . . etc. to reach potential customers by enticing them with an offer or coupon.

The inherent problem with such advertising is that separate ads must be created for each medium. Merchants, especially those small in size are too busy to keep on top of all their advertising needs. Creating and ad for Valpak or Yelp page for instance would have to be re-created for their emailed advertisement and then re-created again for a local community coupon book.

What are needed are systems, methods and computer program products for overcoming the problems described above.

### SUMMARY OF THE INVENTION

To achieve these and other advantages and in order to overcome the disadvantages of the conventional method in accordance with the purpose of the invention as embodied and broadly described herein, the present invention provides systems and methods for assisting merchants in making their advertising and information content available to a wide array of users who do not subscribe to the merchant's newsletters or participate in the merchant's advertising promotions. At least one embodiment consistent with the present invention displays coupons and newsletters on a website, native app or web app to users, via a customized app downloaded from a single host platform of a computer system to users who are not subscribers to the merchant's newsletters or participate in the merchant's advertising promotions.

Methods, systems and computer program products are disclosed which provide a flexible single hosting platform of a computer system configured to aggregate and distribute merchant newsletter/email advertisements and coupons/offers to a plurality of end users.

In a first aspect of the present invention, a method embodiment is disclosed for operating a computer system for aggregating content from a plurality of merchants for distribution to a plurality of users via a single hosting platform, the method comprising the steps of: aggregating content from a plurality of merchants for distribution to a plurality of users via a single hosting platform. The method comprises the steps of receiving, at said computer system, said content comprising at least one of a merchant newsletter or a merchant customized coupon offering from each of said plurality of merchants; parsing, at said computer system, the received merchant newsletters to extract a subject line and newsletter content; aggregating, at said computer system, the parsed merchant newsletter subject line with said newsletter content and said customized merchant coupon offerings into a customized format for insertion into a customized web application; making the customized web application available to users from said computer system.

In a second aspect of the present invention, a system embodiment is disclosed for aggregating content from a plurality of merchants for distribution to a plurality of users, over a network, such as the Internet, via a single hosting platform, the system comprising a content repository, a memory, a server, a network interface, a processor, a merchant an admin computer interface, a content update module, a storage means, a link module, an application service management entity.

According to a third aspect of the invention, a program element directly loadable into a memory of a programmable device is provided comprising software code portions for performing, when said program element is run on a device, the method steps of aggregating content from a plurality of merchants for distribution to a plurality of users via a single hosting platform. The method comprises the steps of receiving, at said computer system, said content comprising at least one of a merchant newsletter or a merchant customized coupon offering from each of said plurality of merchants; parsing, at said computer system, the received merchant newsletters to extract a subject line and newsletter content; aggregating, at said computer system, the parsed merchant newsletter subject line with said newsletter content and said customized merchant coupon offerings into a customized format for insertion into a customized web application; making the customized web application available to users from said computer system.

According to a fourth aspect of the invention, a method embodiment is disclosed for allowing non-opt-in users to view newsletters, the method comprising the acts of: receiving, at a computer system, a plurality of newsletters from a corresponding plurality of newsletter content creators; storing the received plurality of newsletters at the computer system; creating a unique hyperlink for each received newsletter, and displaying the unique hyperlinks on a website page associated with the newsletter content creator.

In one embodiment consistent with the present invention, merchants and vendors login to a system application service management module of a system of the invention, serving as a single hosting platform. The single hosting platform is configured to combine or bundle the merchant's dedicated advertisements (e.g., electronic coupons) and emailed newsletter/email advertisements/ads for distribution to be displayed on user's smart mobile device or other computing systems from the single hosting platform via a downloadable application stored on the user's smart mobile device or other mobile computing system. Users are advantageously able to retrieve product/service information from each of the registered merchants using a single downloadable application available from the hosting platform.

In one embodiment consistent with the present invention, the administrator of a hosting platform of a system of the invention subscribes (opts-in) to a plurality of merchant's email lists and propagate the merchant's current email ad/newsletter/email advertisement/coupon offerings to a large user base of the hosting platform of the invention. The users are shown either on a webpage, blog, web app or dedicated app, both the dedicated advertising from merchants and emailed newsletter/email advertisements/ads without being required to directly opt in to the merchant's email lists. In this manner, the large user base of users are advantageously not required to subscribe to the merchant's newsletter/email advertisement or any other form of merchant solicitation to be able to view the merchant's offerings. In this regard, the system hosting platform acts as content aggregator, bundler and distributor of a plurality of merchant's offerings which are provided to users without the need for registration or by making a download request.

As a further advantage, from the perspective of the merchants is that the merchants can extend their advertising reach beyond their current newsletter/email list to potential customers who have not opted-in to their list. The present invention provides an economy and efficiency in routing the content supplied from multiple content providers through a single web management and distribution service that is responsible for accumulating and storing the merchant content including solicitations for goods and services from the multiple content providers for eventual distribution to users.

In one embodiment consistent with the present invention, a downloadable app or web app, or web page acts as a user hosting platform for receiving content, e.g., dedicated advertisements and emailed newsletter/email advertisements/ads and the like, generated by each registered merchant. In one embodiment, the app running on a user device is adapted to be especially usable as the typical user contemplated is not likely to have much training. In addition, the app is adapted to be modifiable it will typically be needed to be customizable use by various types of users, e.g., maintenance personnel, company officers, etc. Further, the app is adapted to display merchant advertisements and newsletter/email advertisements.

Exemplary embodiments of the present invention also provide a computer program product for implementing the above described systems and methods.

Implementations can realize one or more of the following advantages and features. Enabling companies, merchants, individuals to attract new customers without having, obtaining or sending emails to potential customers. Newsletter/email advertisements are viewed on an app platform that is either mobile based for use with iPhones, iPads and Android and all mobile and non-mobile web enabled devices. Customers do not have to opt-in to an email list and reveal their contact information. Provide improved targeted advertising system that is able to deliver content to a mobile audience that may subsequently conveniently visit the advertiser's business. The methods and systems also provide feedback to advertisers including web analytics and conversion tracking of mobile advertisements that result in sales at their retail locations. Furthermore, significant benefit is also provided by methods and systems of paying via smart mobile phones that are coupled to mobile advertisement systems, and systems that track conversions.

In another embodiment consistent with the present invention a merchant directory web platform can receive newsletters/email ads from participating merchants and store them on their servers. A link can be provided for users to view the current newsletter along with other current information about the merchant such as reviews and contact information.

In one embodiment consistent with the present invention a script may be embedded in third party websites to display a list of merchants who's newsletters can be read by clicking on the offer title.

At least one embodiment consistent with the present invention may be a server for performing one or more of the foregoing acts.

At least one embodiment consistent with the present invention may be performed by client-side device, such as a browser.

The aspects defined above and further aspects of the invention are apparent from the examples of embodiment to be described hereinafter and are explained with reference to these examples of embodiment.

### BRIEF DESCRIPTION OF THE DRAWINGS

These and other objects, features and advantages of the invention will be apparent from a consideration of the following detailed description of the preferred embodiment when taken together with the accompanying drawings, in which:

FIG. 1 illustrates an exemplary ‘opt-in’ system according to the prior art.

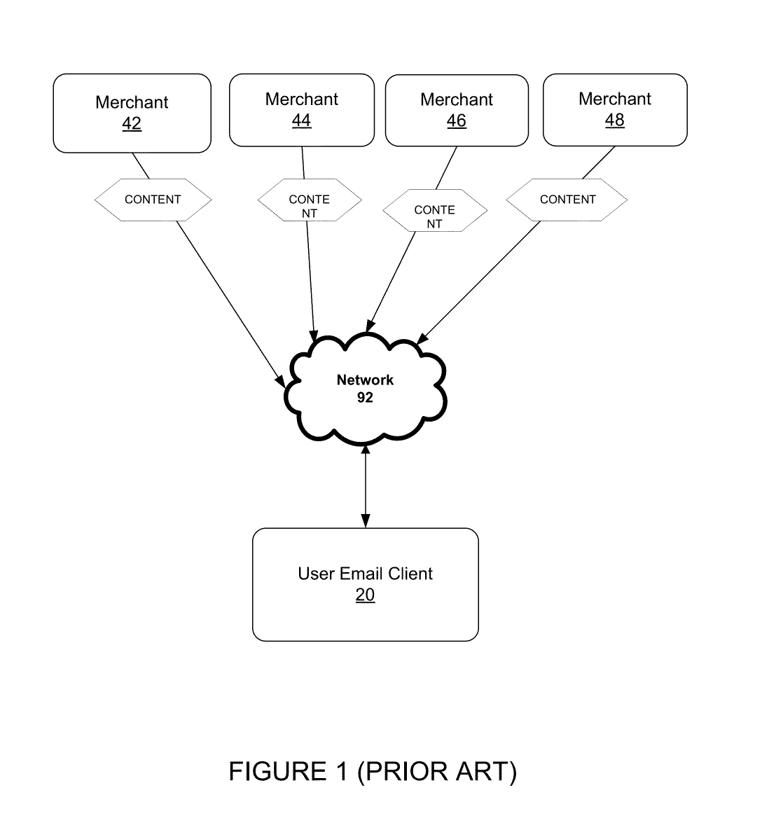

FIG. 2 is a block diagram of a system, according to one embodiment.

FIG. 3 is a flow diagram of an exemplary method that may be used to provide users with the SmartPass mobile application to receive content.

FIG. 4 is a flow diagram of an exemplary method that may be used to allow users (customers) to redeem electronic coupons with merchants with the SmartPass system.

FIG. 5 is a flow diagram of an exemplary method describing merchant interactions with the SmartPass system.

FIG. 6 is a schematic illustration of an exemplary graphical user interface displaying a home screen of the SmartPass system according to one embodiment.

FIG. 7 is a schematic illustration of an exemplary graphical user interface (GUI) displaying an example desktop home page of the SmartPass system, according to one embodiment.

FIG. 8 is a schematic illustration of an exemplary graphical user interface (GUI) that is shown to a user on the user's mobile device when the user selects one of the merchants from the display shown in FIG. 6.

FIG. 9 is a schematic illustration of an exemplary graphical user interface (GUI) that is shown to a user on the user's mobile device when the user depresses the offer title key of the GUI shown in FIG. 8.

FIG. 10 is a schematic illustration of an exemplary graphical user interface (GUI) that is shown to a user on the user's mobile device when the user visits a third-party website that includes banner and/or sponsor ads in accordance with an embodiment of the invention.

FIG. 11 is a flow diagram of an exemplary method that allows merchants to place hyperlinks associated with their merchant newsletters on third-party websites via the SmartPass system for display to users.

FIG. 12 is an exemplary third-party website for a merchant directory.

The figures are schematically drawn and not true to scale, and the identical reference numerals in different figures refer to corresponding elements. It will be clear for those skilled in the art, that alternative but equivalent embodiments of the invention are possible without deviating from the true inventive concept, and that the scope of the invention will be limited by the claims only.

### DETAILED DESCRIPTION

The following exemplary embodiments are set forth to aid in an understanding of the subject matter of this disclosure, but are not intended, and should not be construed, to limit in any way the claims which follow thereafter. Therefore, while specific terminology is employed for the sake of clarity in describing some exemplary embodiments, the present disclosure is not intended to be limited to the specific terminology so selected, and it is to be understood that each specific element includes all technical equivalents which operate in a similar manner. The specific embodiments described herein are illustrative, and many variations can be introduced on these embodiments without departing from the spirit of the disclosure or from the scope of the appended claims. Elements and/or features of different illustrative embodiments may be combined with each other and/or substituted for each other within the scope of this disclosure.

It is further noted that, unless indicated otherwise, all functions described herein may be performed in either hardware or software executed on one or more processors, or some combination thereof. In a preferred embodiment, however, the functions are performed by a processor, such as a computer or an electronic data processor, in accordance with code, such as computer program code, software, and/or integrated circuits that are coded to perform such functions, unless indicated otherwise.

It should be appreciated that the present invention can be implemented in numerous ways, including as a process, an apparatus, a system, a device, a method, or a non-transitory computer readable medium such as a non-transitory computer readable storage medium or a computer network where program instructions are sent over optical or electronic communication links and combinations thereof. Several inventive embodiments of the present invention are described below. It should, thus, be understood that the description to follow is intended to be illustrative and not restrictive, and that many other embodiments will be apparent to those of skill in the art upon reviewing the description.

As will be appreciated by one skilled in the art, the present invention may be embodied as a system, method, computer program product or any combination thereof. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

The system of the invention can be designed for use with a variety of computer platforms, including but not limited to a mobile app which is a small downloadable application also known as a program that runs on a smartphone, tablet or other mobile device. A web app which is an application that runs on the server but displays through the web browser of the smartphone. A web app does not download onto a phone but rather the phone acts like a thin client that interacts with the server. A desktop computer app which is a program that runs on the desktop and has the ability to connect with servers through the internet. A web browser which is commonly written in html and JavaScript written pages that interact with a server and displays on a desktop computer. It is envisioned that the SmartPass system can be used with any smart mobile device or other mobile computing system, e.g., smartphones, handheld devices, handheld computers, tablets or simply handhelds. That is, any pocket-sized computing device, typically having a display screen with touch input, voice activated input or a miniature keyboard. Smartphones and tablets are popular amongst those who require the assistance and convenience of a conventional computer, in environments where carrying one would not be practical. The SmartPass system can also be used with a smart mobile device or other mobile computing systems having a capability of displaying webpages through mobile web browsers.

“Content” may include merchant newsletter/email advertisements including discounted products and/or services embedded in the merchant's newsletter/email advertisements and merchant offers including discounted products and/or services, such as, for example, electronic coupons offered by merchants.

Content from a document may be rendered on a “content rendering application or device”. Examples of content rendering applications include an Internet browser (e.g., Explorer or Netscape), a media player (e.g., an MP3 player, a Realnetworks streaming audio file player, etc.), a viewer (e.g., an Abobe Acrobat pdf reader), etc.

A “content owner” is a person or entity that has some property right in the content of a document. A content owner may be an author of the content. In addition, or alternatively, a content owner may have rights to reproduce the content, rights to prepare derivative works of the content, rights to display or perform the content publicly, and/or other proscribed rights in the content. Although a content server might be a content owner in the content of the documents it serves, this is not necessary.

“User information” may include user behavior information and/or user profile information.

“E-mail information” may include any information included in an e-mail (also referred to as “internal e-mail information”), information derivable from information included in the e-mail and/or information related to the e-mail, as well as extensions of such information (e.g., information derived from related information). An example of information derived from e-mail information is information extracted or otherwise derived from search results returned in response to a search query composed of terms extracted from an e-mail subject line. Examples of information related to e-mail information include e-mail information about one or more other e-mails sent by the same sender of a given e-mail, or user information about an e-mail recipient. Information derived from or related to e-mail information may be referred to as “external e-mail information.”

“Merchant” is used interchangeably herein with the terms “retailer” and “vendor,” and may include any person or entity (e.g., a corporation, a partnership) that sells goods and/or services, whether in the retail or wholesale trade or distributes information freely like blogs or online magazines.

In this document, relational terms such as ‘first’ and ‘second’, and the like may be used solely to distinguish one entity or action from another entity or action without necessarily requiring or implying any actual such relationship or order between such entities or actions. The terms ‘comprises’, ‘comprising’, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by ‘comprises . . . a’ does not, without more constraints, preclude the existence of additional identical elements in the process, method, article, or apparatus that comprises the element.

“Website” is used to refer to a user-accessible network site that implements the basic World Wide Web standards for the coding and transmission of hypertext documents. These standards currently include HTML (the hypertext markup language) and HTTP (the hypertext transfer protocol). Note that the term “site” is not intended to imply a single geographic location as a website or other network site can, for example, include multiple geographically distributed computer systems that are appropriately linked together.

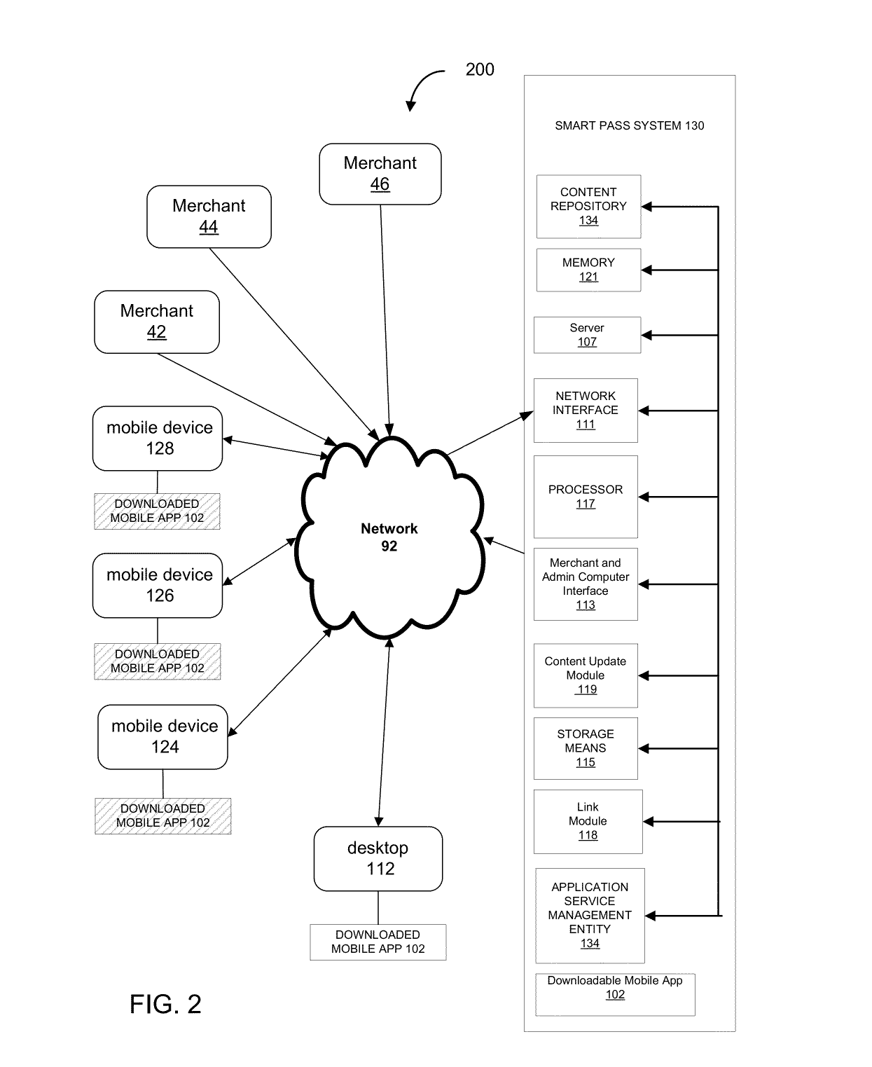

FIG. 2 illustrates an exemplary embodiment 200 of an environment in which a system of the invention may be used. FIG. 2 is a high level diagram of an advertising environment in which one or more general purpose or special purpose computing systems/devices may be used. The environment may include one or more distinct computing systems/devices and may span distributed locations. Furthermore, each block shown may represent one or more such blocks as appropriate to a specific embodiment or may be combined with other blocks. In one embodiment, the system 200 may be implemented in software executed on one or more processors, hardware, firmware, or in some combination to achieve the capabilities described herein.

With continued reference to FIG. 2, the environment includes a single hosting platform, referred to herein as the SmartPass system 130 which communicates with a plurality of mobile devices 124, 126, 128 and a desktop 112 over a network 92, which may be a locale network or the Internet. The SmartPass system 130 includes a processor 117 configured to execute machine readable code, a bus 144 for interconnecting system components within the system SmartPass 130. For example, the processor 117 may use a memory 121 to run code and/or store data. The SmartPass system 130 may also comprise a means to communicate, such as a network interface 111, allowing the SmartPass system 130 to communicate with a plurality of merchants 42, 44, 46, 48, four of which are shown for ease of explanation, and a plurality of smart mobile devices 124, 126, 128 and a desktop 112. A storage means 115 may also be provided for storing content, metadata and intermediate and/or final results of any processing steps. The storage means 115 may also store the downloadable mobile app 102.

The SmartPass system 130 may also comprise a number of hardware/software system management modules to perform specific functions associated with the management of content. In an embodiment, these hardware/software management modules may include a content update module 119 for the purpose of managing content updates received from the various merchants 42, 44, 46, 48. A link module 118 for the purpose of removing any unsubscribe links from delivered newsletter/email advertisement to prevent a user from unsubscribing a merchant 42, 44, 46, 48 from the SmartPass system 130. In one embodiment, the SmartPass system 130 removes text from the merchant's newsletter/email advertisement related to unsubscribing from the merchant's newsletter/email advertisement.

In operation, a user associated with a mobile device 124, 126, 128 downloads a mobile app 102 to the user's smart mobile device 124, 126, 128. An executing mobile app 102 is capable of processing content for presentation to the user. Content is sourced from one or more of the merchant 42, 44, 46 to the application service management entity 134. Content sourcing may be periodic, aperiodic or a combination. The downloaded content is preferably stored at a content repository 136 of the application service management entity 130 for eventual distribution to the smart mobile device 124, 126, 128. The mobile app 102 may be enabled/disabled at the user's discretion. In an enabled state, the executing mobile app 102 displays merchant dedicated advertisements including emailed newsletter/email advertisements/ads and associated title offers 704. The title offers are provided as an inducement to the user to select and read the downloaded merchant's newsletter/email advertisements.

In one embodiment, a user receives content (e.g., the merchant ads and associated newsletter/email advertisements) without having to actively sign-up to the merchant's mailing list. Newsletter/email advertisements are provided to the users without the need for registration or by making a download request.

In accordance with one aspect, the users view the downloaded content (e.g., merchant's ads and newsletter/email advertisements) anonymously. By virtue of not having to register with a content provider site, the users can view downloaded content without giving identifying indicia to the merchants. This is a consequence of a content provisioning system in which a multiplicity of merchants feed their content to a single aggregation site (i.e., SmartPass system) that in turn makes the information available to users via the downloaded SmartPass mobile app 102. Thus, there is no direct line of communication between content providers and content consumers.

Advantageously, a mobile client, or a web client in some embodiments, may easily download content from multiple merchants via the SmartPass hosting platform 130 by downloading the single mobile app 102 to their mobile device 124, 126, 128 instead of being required to individually subscribe to a multiplicity of content provider sites to receive content from each one of the different content sources.

In one embodiment, the downloaded content may include merchant product/service discounts embedded in a merchant newsletter/email advertisement to attract potential customers.

As briefly discussed above, the SmartPass system of the present invention comprises, in one aspect, a downloadable mobile application 102, (widely referred to as an ‘app’), as shown in FIG. 2 as downloaded mobile app 102. The downloaded mobile app 102 is configured to execute on a mobile device such as a smartphone (e.g., iPhone, Android powered phone, etc.), tablet (e.g., iPad, Galaxy, etc.) or other suitable mobile computing platform. The application provides users with the ability to view, display and interact with content in general and in particular with merchant advertisements, newsletter/email advertisements and coupons/offers.

The downloadable mobile application may be embodied in different forms, for example, as a SmartPass native application, web app or as an application on the SmartPass system website.

A user may download the SmartPass mobile application 102 from the SmartPass system server 107 and upon activating the mobile application from the user's mobile device 124, 126, 128, the user is wirelessly connected to the SmartPass server 107 shown in FIG. 2. The SmartPass mobile application is preferably configured to receive the most recently updated newsletter/email advertisements, coupons/offers and other electronic merchant content.

Alternatively, a user may access a SmartPass web page (http://www.SmartPassnetwork.com) hosted on the SmartPass server 107 to download the most recently updated newsletter/email advertisements, coupons/offers and other electronic merchant content. Thereafter, further merchant updates are automatically provided to the user's mobile device whenever the user refreshes the “new offers” screen.

### Exemplary User Related Methods

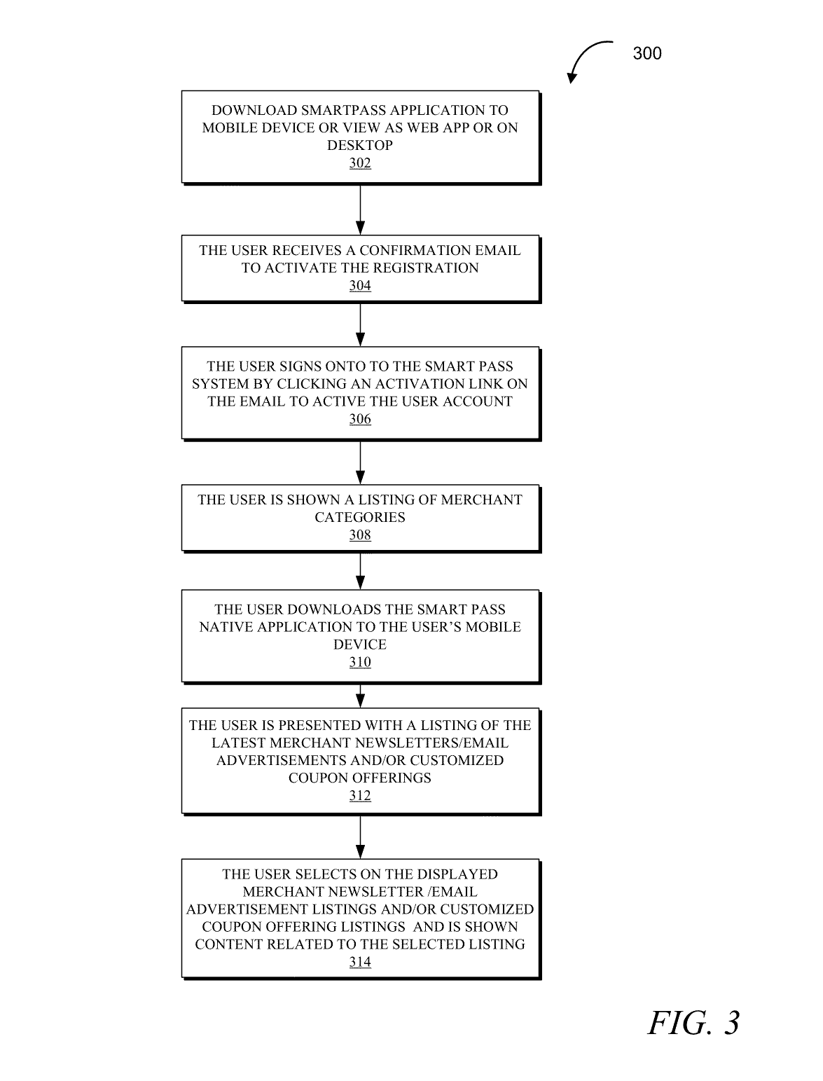

FIG. 3 is a flow diagram of an exemplary method 300 that may be used to provide users with the SmartPass mobile application to receive content, such as the most recently updated newsletter/email advertisements, coupons/offers from merchants on the SmartPass hosting platform 130.

At step 302, a user downloads the SmartPass customized web application as a native app or web app or otherwise accesses the SmartPass customized web application via a web page to register with the SmartPass System by entering at least his or her email address and zip code.

At step 304, a confirmation email is sent to the user to activate the registration.

At step 306, the user signs on to the SmartPass system by clicking an activation link on the email to activate his or her account.

At step 308, in one embodiment, the user may be shown a listing of merchant categories. The user may then select one or more categories from the list of merchant categories shown. The list is saved to customize the user experience in future sessions.

At step 310, a user downloads the SmartPass native application or web app to the user's mobile device. The download may be sourced from any mobile platform app provider such as, for example, itunes and Google Play. Alternatively, the user opens the web app to view the SmartPass application. Otherwise, the user opens the SmartPass web page (http://www.SmartPassnetwork.com) to view the SmartPass application.

At step 312, the user is initially presented a list of the offer titles of the latest merchant newsletter/email advertisements and/or customized coupons/offers. The user can view the latest merchant newsletter/email advertisements and/or customized coupon/offers by clicking on an offer title. The list will include only those merchants that fall within a geographical radius limitation imposed on the merchants by the SmartPass system. In one embodiment, a system administrator determines for each merchant, a geographical radius threshold. The threshold is used in relation to a user's current geographical search location. That is, if a user's geographical search location is determined to fall outside of the geographical radius threshold of the merchant, the user will not be able to view the latest newsletter/email advertisements and/or customized coupon/offers from that merchant. For example, a threshold for merchant A's is set at 5 miles. In the event the user is outside the 5 mile radius of the merchant, the user will not be able to view the offerings from that merchant.

In one embodiment, the user has the option of searching using predetermined search criteria. In one embodiment, the user has the option of searching via different criteria including, for example, “town”, “bookmark” or “category.” If the user elects to view the latest merchant offerings by “town”, the user selects a town from a menu and is shown a list of all merchants in that town. If the user elects to view the latest merchant offerings by “bookmark”, the user will see a list of merchants that are previously bookmarked by the user. If the user elects to view the latest merchant offerings by “category”, a list of merchants is shown for that category that fall within the geographical radius limitation imposed on the merchant by the SmartPass system.

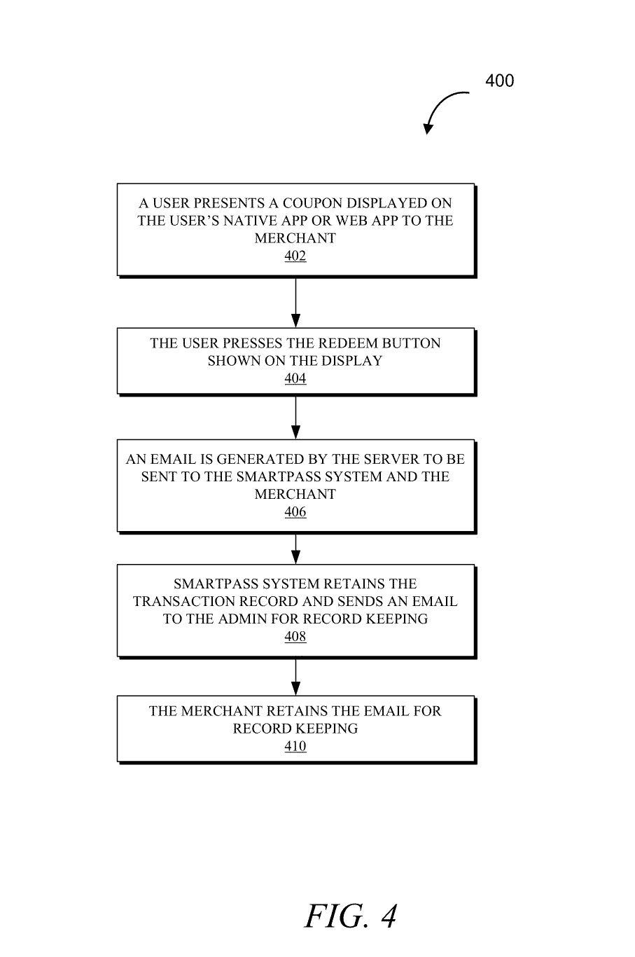

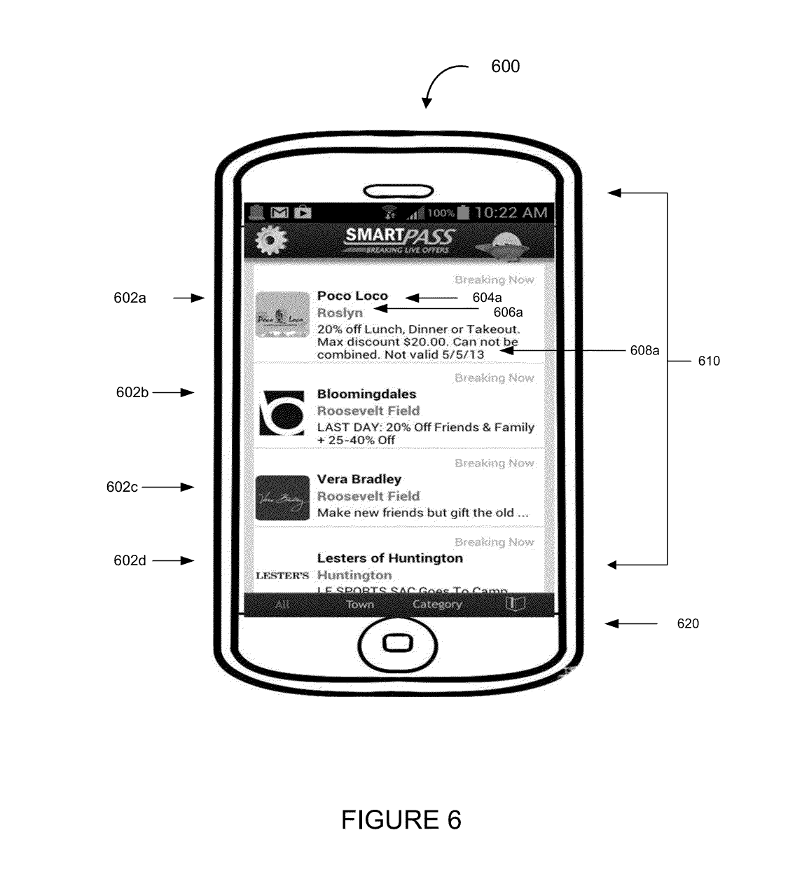

At step 314, the user views the merchant newsletter/email advertisements and/or customized coupon/offer, as shown in FIG. 6. The user can select the offer title 908 which causes the app/web app/website to display the content of the newsletter/email advertisement or content of the customized coupon/offer. In the case where the user views a redeemable coupon, the user may redeem the coupon with the merchant. This process is described more fully with respect to the flowchart of FIG. 4 as follows.

FIG. 4 is a flow diagram of an exemplary method 400 that may be used to allow users (i.e., customers) to redeem electronic coupons with merchants via the SmartPass hosting platform.

At step 402, a user presents a coupon displayed on the user's native app or web app to a merchant.

At step 404, the user presses the “redeem” button shown on the display. The user is then shown a subsequent screen displaying a safety message stating that an email will be generated and sent to the merchant with the user's mobile device ID upon the user pressing the “submit” button. In one embodiment, the email includes at least the mobile device ID, the user ID given to the user by the SmartPass system, the town provided by the user when the user registered with the SmartPass system and the details of the coupon offer.

At step 406, upon the user pressing the “submit” button, an email is generated by the SmartPass Server and recorded by the SmartPass system and an email is sent to the merchant.

At step 408, upon receiving the email from the user, the SmartPass system retains the email for record keeping purposes.

At step 410, upon receiving the email from the user, the merchant retains the email for record keeping purposes.

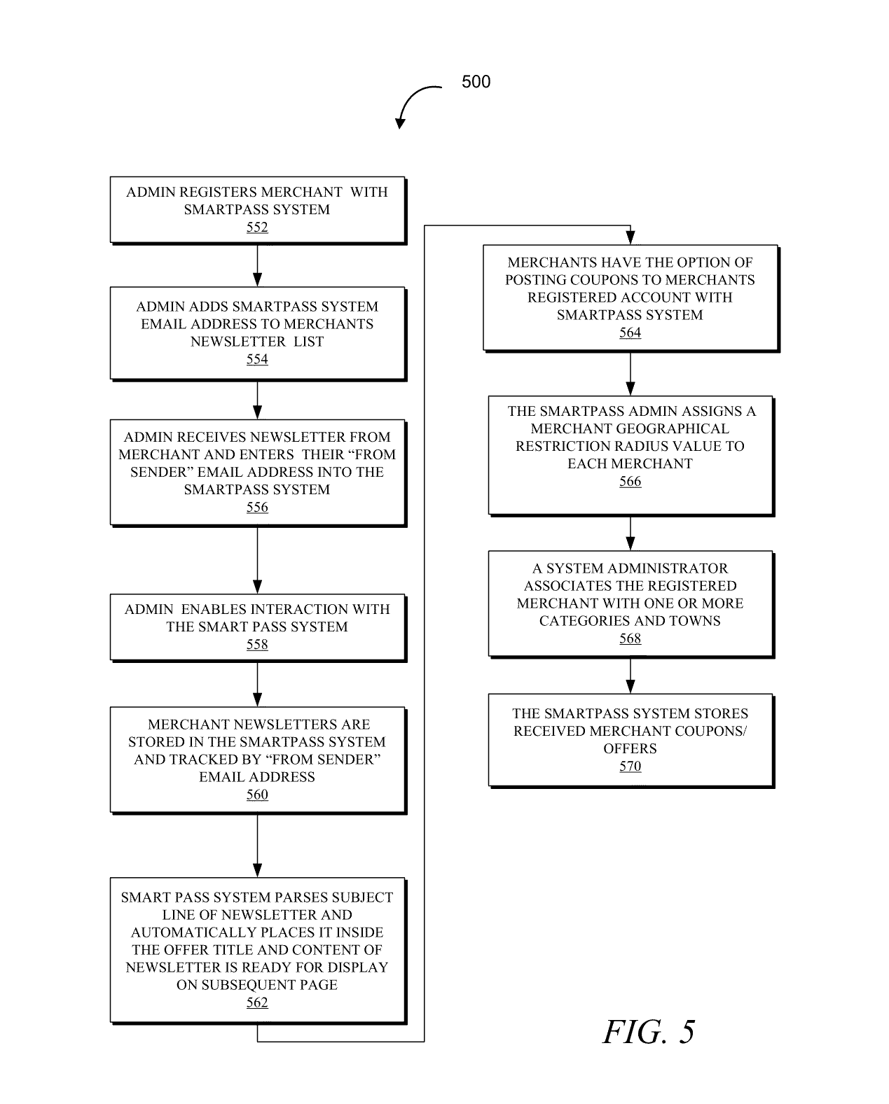

FIG. 5 is a flow diagram of an exemplary method 500 describing merchant interactions with the SmartPass system.

Prior to registering merchants into the SmartPass system, a merchant logo is created by the SmartPass admin to be displayed simultaneous with the offer title of the merchant newsletter/email advertisement.

At step 552, a system administrator registers the merchant with the SmartPass system.

At step 554, merchant adds the SmartPass system email address, SmartPassnews@bluemail.com, to the merchant's newsletter/email advertisement list on merchant's website for the

[symbol]

At step 556, the SmartPass admin receives newsletter/email advertisements at SmartPassnews@bluemail.com, from registered merchants and enters the merchant's “from sender” email address into the SmartPass system 130 for tracking purposes to associate the merchant's logo and associate the registered merchant with each newsletter/email advertisement received from the merchant over time.

At step 558, the SmartPass admin has the ability to enable/disable interaction with the SmartPass system 130 via an enable/disable feature on the admin panel.

At step 560, merchant newsletter/email advertisements are stored in the storage means 115 of the SmartPass system 130.

At step 562, upon receiving the merchant newsletter/email advertisements at the SmartPass system 130, the system parses the subject line from the content of the newsletter/email advertisement and places the parsed subject line inside the Offer Title 608, for display with the logo of the merchant 602, as the home page shown in FIG. 6. The parsed content portion is made ready for display on a subsequent page linked to the home page, which is retrievable by the user depressing the Offer Title button 608. This automated process of parsing subject line from content is performed by the SmartPass system 130 requiring no merchant interaction. That is, the SmartPass system 130 assumes responsibility for parsing the subject line from the content of the various merchant newsletter/email advertisements.

At step 564, the registered merchants have the option of posting coupons to the merchant's registered account with the SmartPass system 130. The merchant or the Admin are authorized to log into the merchant account at the SmartPass system 130 and is provided with the ability to post electronically redeemable coupons or offers separate from the merchant's newsletter/email advertisements.

At step 566, the SmartPass admin assigns a merchant geographical restriction radius threshold value to each merchant. When a user attempts to view merchant offerings, either on the user's mobile device or desktop, the user's current position is determined by GPS on the user's mobile device or by zip code on the user's desktop. The user will only be shown offerings from those merchants whose user position is within the assigned predetermined merchant geographical restriction radius as set by the Admin. In the alternative, if a user wishes to view offerings (e.g. offerings/coupons) from those merchants whose restriction radius falls outside of the current user position, the user may access those merchant offerings by searching individual merchants by “Town”.

At step 568, a system administrator associates the registered merchant with one or more categories and town. For example, a merchant may be entered into “Mineola” for the town and into three categories independent of the town categorization: “Italian eatery”, “Restaurant”, “Pizza”.

At step 570, SmartPass system stores received merchant coupon/offers.

FIG. 6 is a schematic illustration of an exemplary graphical user interface (GUI) 600 displaying an example home page 600 of the SmartPass system, according to one embodiment. In the example embodiment, upon launching the application, the screen presented is generally divided into two parts and include a display part 610 and a search part 620.

The GUI 600 is displayed in a merchant list view which includes, for each merchant, a merchant logo 602a, a merchant name 604a, a merchant town 606a and a merchant offer title 608a. The merchant offer title 608a can be, in different embodiments, the subject line from the newsletter/email advertisement email or the offer title entered for the coupon and for the mobile native app, the user is also shown an indication of when the offer was made available to the SmartPass system.

The search part 620 includes a number of search icons to allow a user to search for a merchant by different criteria such as: (1) town, (2) bookmark, (3) category, (4) new offer, current location. The different criteria are described in greater detail as follows.

1) Search by Town—User selects a town that they would like to shop in. A lead off picture of that town is the first image shown. User slides the image to the left and merchant display ads are presented one at a time. The Offer Title at the bottom of the screen displays the Subject line from the Newsletter/email advertisement. At the bottom right is a button when pressed will display the newsletter/email advertisement from the merchant.
2) Bookmarks—Users while using the app (or website) can bookmark particular merchants of interest. These bookmarked merchants can then be searched independently of any other merchant regardless of town. Search results will order the merchants according to current location of the user.
3) Search by Category—User selects a category in which he would like to shop. For example ‘Restaurants’ is selected. In the same manner as described in #1 merchant display ads are presented but only of restaurants. The search results are listed in order of user proximity.
4) Current Location—All merchants are viewed in the order of current location of the user.
5) New Offers—When a merchant sends out a newsletter/email advertisement, the subject line will be displayed in the app on the New Offers screen and listed first. Also push notification of ‘Breaking New Offers’ will notify the user that a new merchant offer has been made. Breaking New Offers can be set to ‘All’ merchants or ‘Bookmarked’ merchants only.

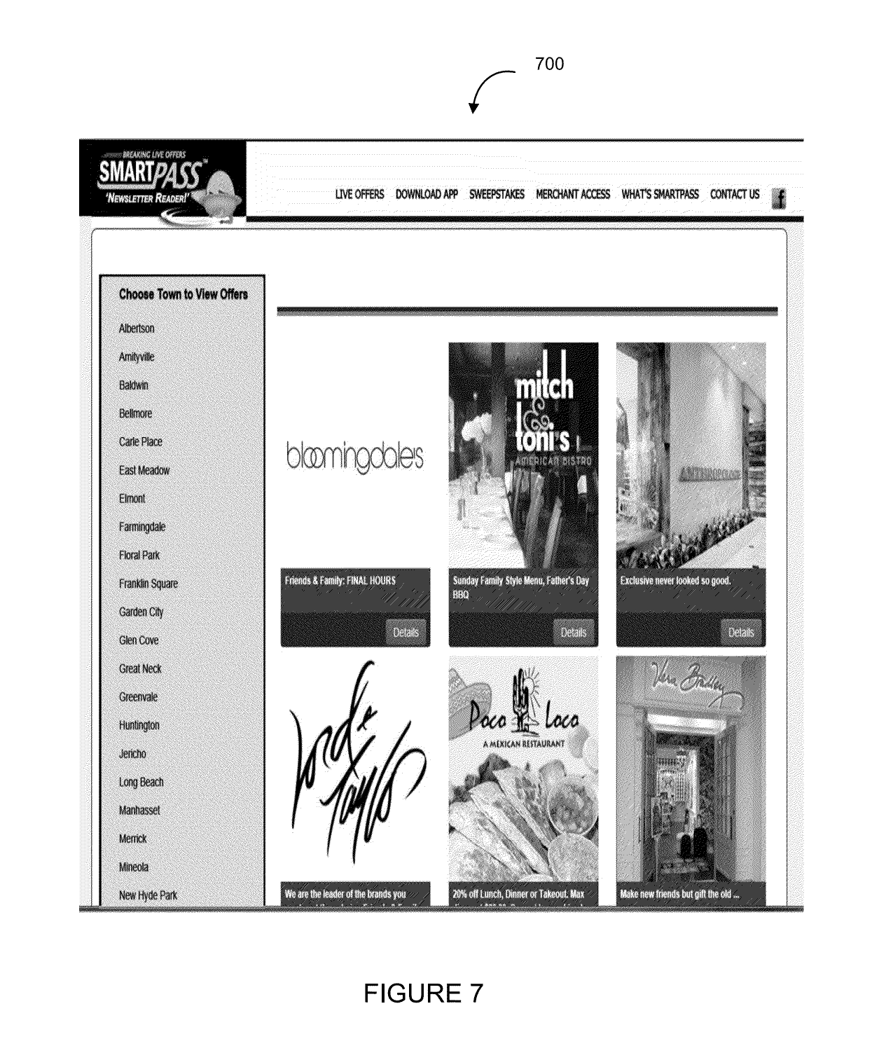

FIG. 7 is a schematic illustration of an exemplary graphical user interface (GUI) 700 displaying an example desktop home page of the SmartPass system 130, according to one embodiment. The presented screen is generally divided into two parts including a first part on the left related to “search by town” and a second part on the right related to merchant offers.

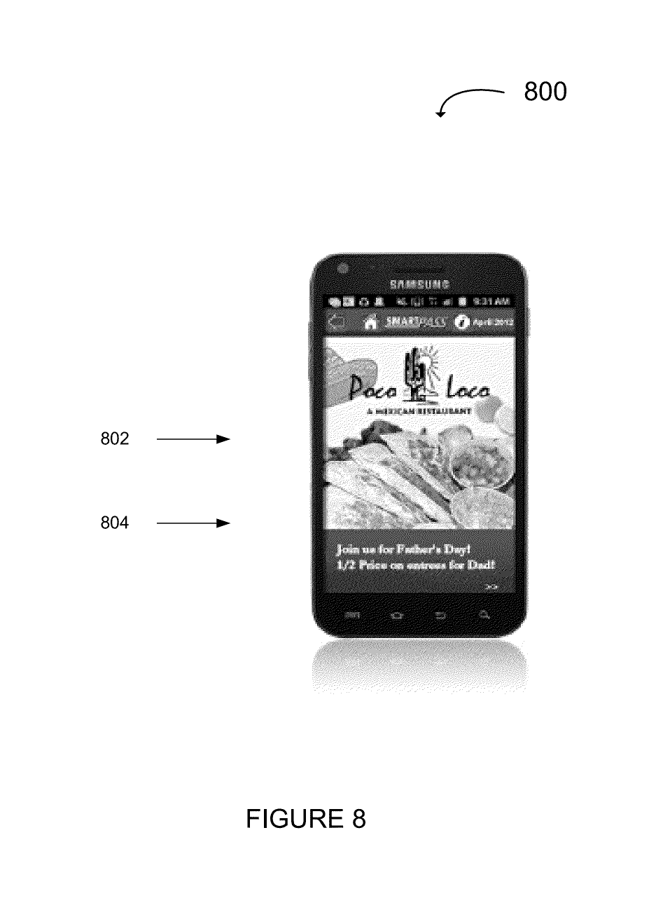

FIG. 8 is a schematic illustration of an exemplary graphical user interface (GUI) 800 that is shown to a user on the user's mobile device when the user selects one of the merchants from the display shown in GUI 600 of FIG. 6. By way of example only, when a user selects the “Poco Loco” merchant from the list of merchants shown in GUI 600, the user is shown display ad 802 of the merchant and a corresponding offer title 804. The offer title 804 can be, for example, as shown, an offer for discounted dinner at the “Poco Loco” restaurant. The details of the offer can be obtained by the user by selecting the arrow keys located on the lower right corner of the smart mobile device.

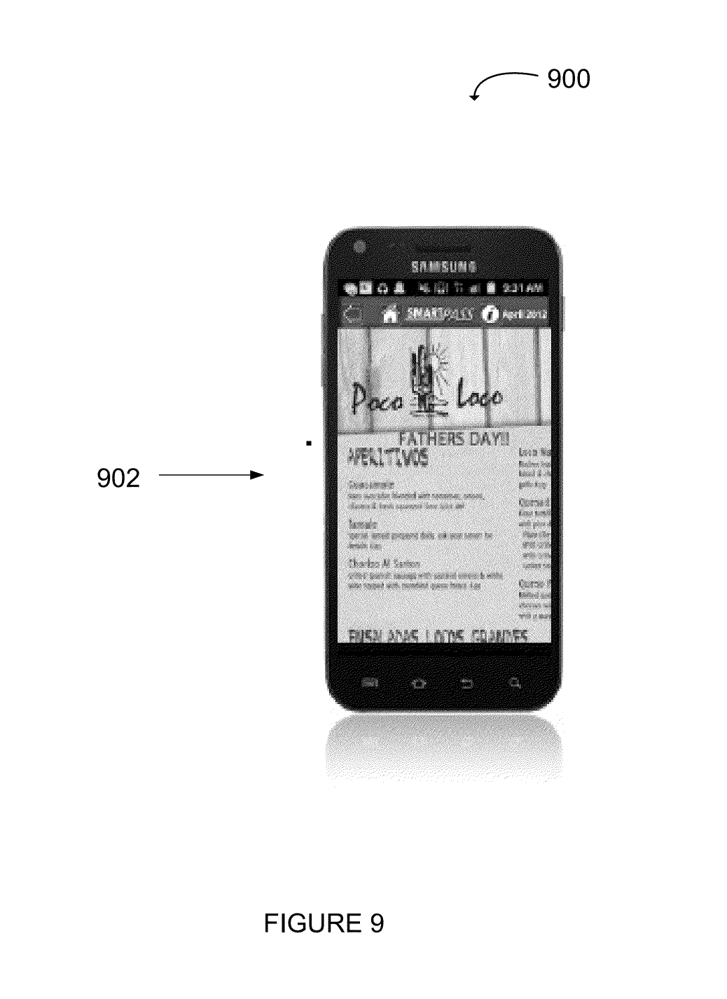

FIG. 9 is a schematic illustration of an exemplary graphical user interface (GUI) 900 that is shown to a user on the user's mobile device when the user depresses the offer title key 804 of the GUI 800 shown in FIG. 8. The user is shown the most current newsletter/email advertisement 902 of the “Poco Loco” merchant providing more detailed information associated with the offer title key 804 of the GUI 800 shown in FIG. 8.

According to one embodiment, the merchant newsletters may be configured as web page-based ads in the same manner as conventional web page-based ads. Web page-based ads (also referred to as “Web ads”) are well-known and are often presented to their target audience in the form of “banner ads” (i.e., a rectangular box that includes graphic components), or as “sponsored link” ads which a list of linked Web pages are provided. These links usually correspond in some way to the content of the current or previous search or the content of the webpage. Some Web pages use various targeting techniques to present more relevant ads, and therefore more useful ads, to users. For example, the Google search engine processes a search query to generate search results pages. In addition to search results, these pages may include ads targeted to keywords of the search query. As another example, ads may be targeted to topics or concepts of the content of a Web page. When a member of the advertised audience (referred to as a “viewer” or “user” in the Specification without loss of generality) selects one of these ads by clicking on it, embedded hypertext links typically direct the viewer to a Web page (which may be referred to as the “landing page” of the ad) of the advertiser's Website where they can be presented with marketing information, and/or consummate a transaction. A user selection of an ad is commonly referred to as a “clickthrough.” As used in the Specification, “Clickthrough” is intended to cover any user selection. For example, when a user selects one of the ads of the so-called “banner-ads”, they are brought to (e.g., their browser loads) a corresponding ad landing page linked from the ad. Similarly, when a user selects one of the ads of the “sponsored links”, they are brought to a corresponding ad landing page 150 linked from the ad. As stated above, these landing pages typically take the viewer to the advertiser's Website where they can be presented with marketing information, and/or consummate a transaction.

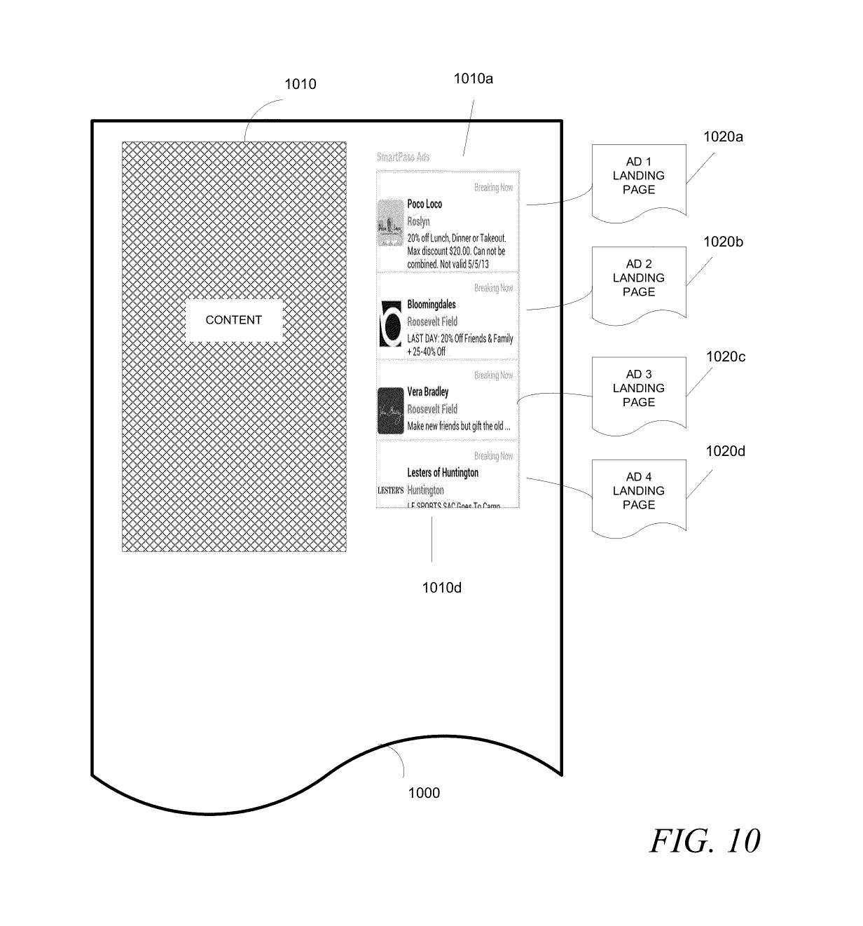

FIG. 10 is a schematic illustration of an exemplary graphical user interface (GUI) 1000 that is shown to a user on the user's mobile device when the user visits a third-party website that includes banner and/or sponsor ads in accordance with an embodiment of the invention. As shown, banner/sponsor ads 1010, four of which are shown to the user 1010a, . . . , 1010d, may be selected by the user in a so-called Clickthrough. When a user selects one of the ads 1010 of the so-called “banner-ads” and “sponsor-ads”, they are brought to (e.g., their browser loads) a corresponding ad landing page 1020 linked from the ad. In the present embodiment, the ad landing page presents to the user is not an advertisement of the merchant but is instead a current newsletter of the merchant, which was previously loaded and stored on the Smartpass system 130. The merchant newsletter would be shown to the user in the same manner as illustrated in FIG. 9.

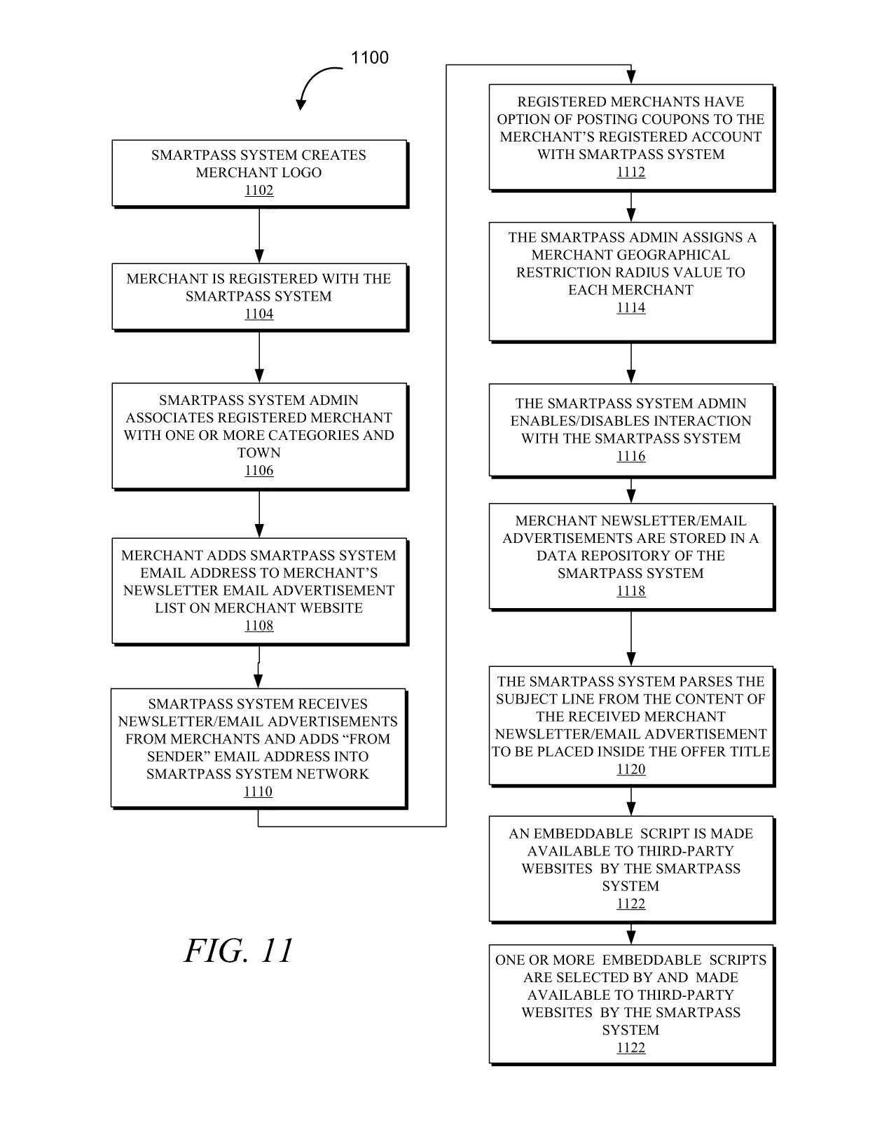

FIG. 11 is a flow diagram of an exemplary method 1100 that allows merchants to place hyperlinks associated with their merchant newsletters on third-party websites via the SmartPass system for display to users.

At step 1102, prior to registering merchants into the SmartPass system, a merchant logo is created by the SmartPass admin to be displayed simultaneous with the offer title of the merchant newsletter/email advertisement.

At step 1104, a system administrator registers the merchant with the SmartPass system.

At step 1106, a system administrator associates the registered merchant with one or more Categories and town. For example, a merchant may be entered into “Mineola” for the town and into three categories: “Italian eatery”, “Restaurant”, “Pizza”.

At step 1108, merchant adds the Smartpass system email address, SmartPassnews@bluemail.com, to the merchant's newsletter/email advertisement list on merchant's website for the purpose of enabling the SmartPass system to receive newsletter/email advertisements from the merchants.

At step 1110, the SmartPass admin receives newsletter/email advertisements at SmartPassnews@bluemail.com, from merchants and enters the merchant's “from sender” email address into the SmartPassNetwork system for tracking purposes to associate the merchant's logo and associate the registered merchant with the newsletter/email advertisement.

At step 1112, the registered merchants have the option of posting coupons to the merchant's registered account with the SmartPass system. The merchant or the Admin are authorized to log into the merchant account at the SmartPass system and is provided with the ability to post electronically redeemable coupons or offers separate from the merchant's newsletter/email advertisements.

At step 1114, the SmartPass admin assigns a merchant geographical restriction radius value to each merchant. When a user attempts to view merchant offerings from a third party website, either on the user's mobile device or desktop, the user's current position is determined by GPS on the user's mobile device or by the router position serving the desktop. The user will only be shown offerings from those merchants whose user position is within the assigned predetermined merchant geographical restriction radius as set by the Admin.

At step 1116, the SmartPass system administrator enables/disables interaction with the SmartPass system via an enable/disable feature on the admin panel.

At step 1118, merchant newsletter/email advertisements are stored in the data repository of the SmartPass system. The newsletters are automatically replaced by newer versions as they arrive from the merchants. The newsletters are automatically turned off after a predetermined amount of time by the SmartPass system administrator after a predetermined time. The time can be on the order of days (e.g., 7 days, 14 days, 21 days, etc. . . . )

At step 1120, upon receiving the merchant newsletter/email advertisements at the SmartPass system, the system parses the subject line from the content of the newsletter/email advertisement and places the parsed subject line inside the Offer Title 704, for display with the logo of the merchant, as shown in FIG. 7, under the display ad 702. The parsed content portion is made ready for display on a following page and may be retrieved by activating a button on the Offer Title page 704. This automated process requires no merchant interaction. The SmartPass system assumes responsibility for parsing the subject line from the content of the various merchant newsletter/email advertisements. In one embodiment, instead of using the parsed subject line, a custom subject line can be created to be used as ad words for an embeddable script.

At step 1122, An embeddable script for embedding objects is made available to third party websites by the SmartPass system to embed a SmartPass module on one or more pages of the third party website. The SmartPass module will display the logo and the subject line of the merchant newsletter (i.e., offer title) and or merchant coupons as a hyperlink on the third party website. The offer titles are clickable hyperlinks which when selected brings the user to a new page displaying the merchant's newsletter or coupon advertisement.

At step 1124, the third-party websites embed one or more merchant scripts selected by the SmartPass system for inclusion in the display on the third-party website. Much like a google ad, the merchants to be displayed on the third-party website are programmatically chosen by the SmartPass system to be embedded in the third-party website.

In another embodiment, merchant directory sites typically provide a wealth of information for each merchant, such as, Name, address, photos, offers or coupons, and reviews by users. In the present embodiment, it is contemplated to further include a hyperlink as an additional information item to be added to the merchant directory page of merchant directory sites, where the hyperlink is a link to the current newsletter of that merchant.

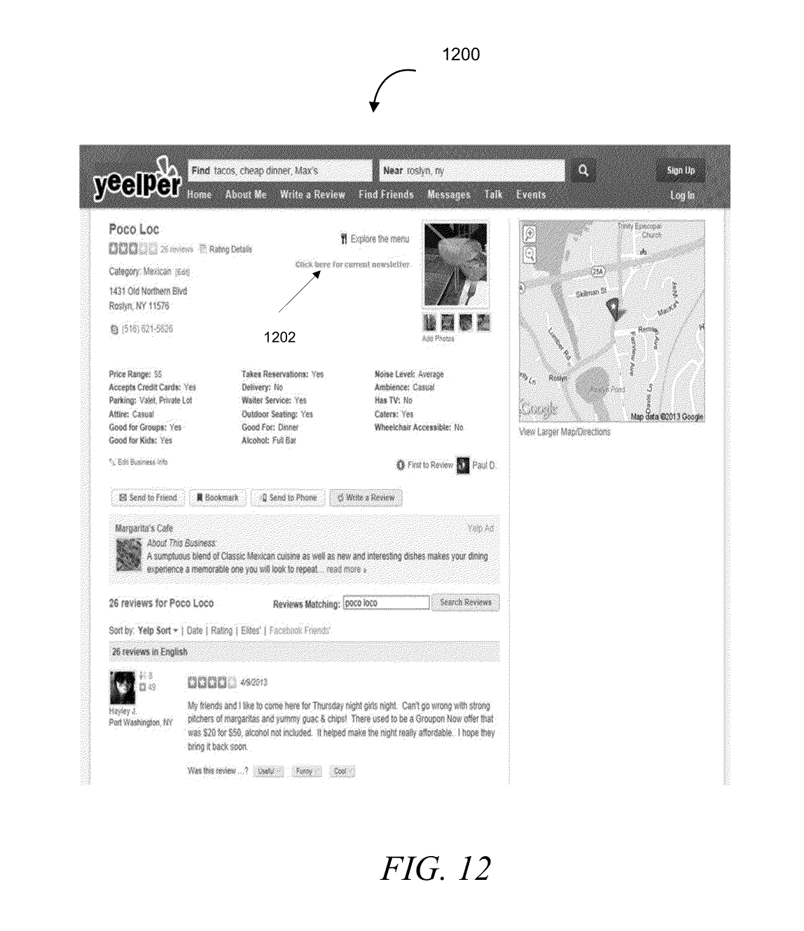

FIG. 12 is an exemplary third-party website for a merchant directory. The website includes conventional information, such as, name, address, photos, offers or coupons, and reviews by users, and additionally includes a hyperlink associated with the merchant's newsletter 1202. When a user depresses hyperlink 1202, he will be brought to a display page of the body of the merchant newsletter that may be stored on the merchant directory server or on the SmartPass system server. In either case, the merchant server and the SmartPass system server hosts hyperlinks for a large community of merchants.

In operation, a hyperlink is uniquely created for each merchant linking to the newsletter. In one embodiment the newsletters are stored on the merchant directory server to be linked to a corresponding hyperlink. In another embodiment, the newsletters are stored on the SmartPass system storage medium to be linked to a corresponding hyperlink. A non-opt-in user may view the merchant newsletter by depressing the displayed hyperlink on the merchant directory website.

Newsletters arrive at the respective servers in the manner described above with reference to the flowcharts of FIGS. 5 and 11.

In accordance with a method embodiment, a method for allowing non-opt-in users to view newsletters, the method comprising the acts of: receiving, at a computer system, a plurality of newsletters from a corresponding plurality of newsletter content creators; storing the received plurality of newsletters at the computer system; creating a unique hyperlink for each received newsletter, and displaying the unique hyperlinks on a website page associated with the newsletter content creator.

### Example

A SmartPass Network Coupon Platform is configured to distribute coupons and email advertisements from a multiplicity of merchants. SmartPass Network Coupon Platform signs up merchants (e.g., The Red Turtle (a burger sports bar)) to the SmartPass platform. At the point of registration, the SmartPass platform adds its email address to the Red Turtle's email list. From that point on, the Red Turtle email ads will be sent to the SmartPass network via the platform.

To set up of the Red Turtle account—A logo of the Red Turtle is uploaded to the SmartPass server as well as account contact information for this merchant.

Process of displaying the Red Turtle ad—An email advertisement from the Red Turtle arrives in the ‘in box’ of the SmartPass Network email account. SmartPass through the use of custom software parses that email into two parts, (1) the subject line and (2) the body of the email.

Display of ads—On the SmartPass Network there are coupons and offers that are displayed for the web and web app or dedicated app from a multiplicity of merchants including the Red Turtle. These coupons or offers were given to Smartpass from the merchants for display to users or otherwise, the merchant signed into to their own account and created the ads them themselves.

In the account of the merchant there is the ability to enable the email advertisement. The admin or the merchant puts in the email address from where it was sent (e.g. info@theredturtle.com and select the categories that the merchant falls under and then enables the email propagator.

When the SmartPass website is viewed by users, it displays the custom offer/coupons from merchants in addition to the email newsletter/email advertisements/ads sent from the merchant. The merchant doesn't have to do anything from that point onward. Every time the merchant sends out an email advertisement to subscribers like SmartPass, the advertisement will automatically appear on the SmartPass Network including website, web apps, or dedicated apps.

If the SmartPass website is viewed on an app or a small mobile device only the subject line of the email advertisement will be presented in list view along with the title of coupon/offer and then subsequent pages will follow when the ad is pressed by an user to display the full content of the email ad or the full content of the coupon/offer. List view is used to condense information into a small screen space.

Embed—Google ads allows website content providers to embed google ads on their sites to earn money for the display of those ads. The email propagator can also be displayed in a similar fashion on any content provider's website. The difference is that merchant will never have to change the ad. The embed script will always pull information from the latest email sent out from the merchant. This keeps the information relevant and fresh without any extra effort from the merchant.

Computer program code for carrying out operations of the present invention may be written in any combination of one or more programming languages, including an object oriented programming language such as Java, Smalltalk, C++, C# or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The invention may be described in the general context of computer-executable instructions, such as program modules, being executed by a computer. Generally, program modules include routines, programs, objects, components, data structures, etc. that performs particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented or supported by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The computer readable and computer executable instructions reside, for example, in data storage features such as computer usable memory and storage components associated with the respective components of FIG. 2. However, the computer readable and computer executable instructions may reside in any type of computer readable medium. Although specific steps are disclosed in the flowcharts described herein, such steps are exemplary. That is, the present invention is well suited to performing various other steps or variations of the steps recited in the exemplary flowcharts. Within the present embodiment, it should be appreciated that the steps of the flowcharts may be performed by software executable by one or more processors, by hardware or by any combination of software and hardware.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The invention is operational with numerous general purpose or special purpose computing system environments or configurations. Examples of well-known computing systems, environments, and/or configurations that may be suitable for use with the invention include, but are not limited to, personal computers, server computers, cloud computing, hand-held or laptop devices, multiprocessor systems, microprocessor, microcontroller or microcomputer based systems, set top boxes, programmable consumer electronics, ASIC or FPGA core, DSP core, network PCs, minicomputers, mainframe computers, distributed computing environments that include any of the above systems or devices, and the like.

From the foregoing it will be appreciated that, although specific embodiments have been described herein for purposes of illustration, various modifications may be made without deviating from the spirit and scope of the invention.

What is claimed is:

1. A method of operating a computer system for aggregating content from a plurality of merchants for distribution to a plurality of users via a single hosting platform, the method comprising the steps of:
i) receiving, at said computer system, said content comprising at least one of a merchant newsletter or a merchant customized coupon offering from each of said plurality of merchants;
ii) parsing, at said computer system, the received merchant newsletters to extract a subject line and newsletter content;
iii) aggregating, at said computer system, the parsed merchant newsletter subject line with said newsletter content and said customized merchant coupon offerings into a customized format for insertion into a customized web application;
iv) making the customized web application available to users from said computer system.

2. The method of claim 1, further comprising the steps of:
automatically receiving at the computer system, periodic updates of the merchant newsletters; and
automatically replacing, at the computer system, the current merchant \ newsletter currently residing in the customized web application with the received, updated merchant newsletter, independent of user interaction.

3. The method of claim 1, wherein said customized web application comprises at least a first and a second display page, wherein said first display page comprises a list of merchant logos and associated offer titles, wherein said offer titles are hyperlinks linking said first and second display pages.

4. The method of claim 3, wherein said second page comprises said merchant newsletter content parsed from said received merchant newsletters.

5. The method of claim 1, wherein said customized web application is one of a web platform, a website, a native web application, a web app.

6. A method for allowing non-opt-in users to view newsletters, the method comprising the acts of:
i) receiving, at a computer system, a plurality of newsletters from a corresponding plurality of newsletter content creators;
ii) storing the received plurality of newsletters at the computer system;
iii) creating a unique hyperlink for each received newsletter, and
iv) displaying the unique hyperlinks on a website page associated with the newsletter content creator.

7. The method of claim 6, where the website page is a merchant directory website page.

8. The method of claim 6, where the newsletter content creator is an advertising merchant.
